(19) United States
(12) Patent Application Publication
(10) Pub. No.: US 2024/0268525 A1
(43) Pub. Date: Aug. 15, 2024

(54) WEARING MEMBER AND WEARABLE ELECTRONIC DEVICE COMPRISING SAME

(71) Applicant: SAMSUNG ELECTRONICS CO., LTD., Suwon-si (KR)

(72) Inventors: Jinwook KIM, Suwon-si (KR); Juan LEE, Suwon-si (KR)

(21) Appl. No.: 18/647,390

(22) Filed: Apr. 26, 2024

Related U.S. Application Data
(63) Continuation of application No. PCT/KR2022/016480, filed on Oct. 26, 2022.

(30) Foreign Application Priority Data
Oct. 26, 2021 (KR) 10-2021-0143171
Mar. 17, 2022 (KR) 10-2022-0033447

(51) Int. Cl. A44B 11/10

(52) U.S. Cl. CPC A44B 11/10

(57) ABSTRACT

A wearing member according to various embodiments of the present disclosure comprises: a strap comprising a first strap and a second strap; and a fastening member comprising a first fastener and a second fastener, wherein the first strap is configured to pass through the first fastener including a first magnet, the second strap is fixed to one end of the second fastener including a second magnet, the first fastener and the second fastener are formed to be stacked and coupled to each other, and on a cross-section with respect to the lengthwise direction of the strap, a normal line with respect to a coupling surface between the first fastening member and the second fastening member may have an angle greater than 90-degree with a tensile direction of the second strap applied to the second fastening member.

### CROSS-REFERENCE TO RELATED APPLICATIONS

This application is a continuation of International Application No. PCT/KR2022/016480 designating the United States, filed on Oct. 26, 2022, in the Korean Intellectual Property Receiving Office and claiming priority to Korean Patent Application Nos. 10-2021-0143171, filed on Oct. 26, 2021, and 10-2022-0033447, filed on Mar. 17, 2022, in the Korean Intellectual Property Office, the disclosures of each of which are incorporated by reference herein in their entireties.

### BACKGROUND

### Field

The disclosure relates to devices, for example, a wearing member and a wearable device including the same.

### Description of Related Art

Typically, an electronic device may refer, for example, to a device that performs a predetermined function according to installed programs (e.g., an electronic scheduler, a portable multimedia reproducer, a mobile communication terminal, a tablet PC, an image/sound device, a desktop/laptop PC, and/or a vehicle navigation system), as well as a home appliance. With the increase in the integration of electronic devices and the generalization of high-speed, high-capacity wireless communication, various functions can be installed in a single miniaturized electronic device, such as a mobile communication terminal. For example, in addition to communication functions, entertainment functions such as games, multimedia functions such as music/video playback, communication and security functions for mobile banking, schedule management functions, and electronic wallet functions, are being integrated into a single electronic device.

Recently, wearable devices that can be worn on a body have been commercialized, and mobile communication terminals and wearable devices are being daily used. Since a wearable device may be maintained for a considerable amount of time in the state of being in contact with a user's body, the electronic device may be useful for medical or health care. For example, depending on the mounted sensor, the electronic device is capable of detecting biometric information such as a user's photoplethysmograph (PPG), sleep zone, skin temperature, heart rate, or electrocardiogram, and the detected biometric information may be stored in the electronic device or transmitted to a medical institution in real time and used for the user's health care. In general, electronic devices have a bar shape, box shape, or flat plate shape, but wearable devices may have a number of segments which can be combined to correspond to the curvature of the user's body and in consideration of convenience of wearing. For example, a wrist-worn electronic device may include a housing that accommodates various circuit devices and serves as a main body, and at least one wearing member.

The above-described information may be provided as background for the purpose of aiding understanding of the disclosure. No claim or determination is made as to whether any of the foregoing may be applied as a prior art in connection with the disclosure.

### SUMMARY

According to various example embodiments of the disclosure, a wearing member may include: a strap including a first strap and a second strap, and a fastening member including a first fastener and a second fastener, wherein the first strap may pass through the first fastener comprising a first magnet, the second strap may be fixed to one end of the second fastener comprising a second magnet, the first fastener and the second fastener may be configured to be stacked and coupled to each other, and on a longitudinal cross section of the strap, a normal line with respect to a coupling surface between the first fastener and the second fastener may have an angle greater than 90 degrees with a tensile direction of the second strap applied to the second fastener.

According to various example embodiments of the disclosure, a wearable device may include: a display assembly comprising a display and including a first fixing portion and a second fixing portion, a fastening member including a first fastener and a second fastener, and a strap connected to the display assembly and including a first strap connected to the first fixing portion and a second strap connected to the second fixed portion, wherein the first strap may pass through the first fastener comprising a first magnet, the second strap may be fixed to one end of the second fastener comprising a second magnet, the first fastener and the second fastener may be configured to be stacked and coupled to each other, and on a longitudinal cross section of the strap, a normal line with respect to a coupling surface between the first fastening member and the second fastening member may have an angle greater than 90 degrees with a tensile direction of the second strap applied to the second fastener.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIGS. 1A and 1B are perspective views illustrating an example wearable device according to various embodiments;

FIG. 2A is an exploded perspective view of a strap and a fastening member in the state in which the fastening member is separated according to various embodiments;

FIG. 2B is a diagram illustrating a side view of the strap and the fastening member in the state in which the fastening member is separated according to various embodiments;

FIG. 3A is a perspective view of the strap and the fastening member in which a cross section cut along plane A in FIG. 2A is illustrated in the state in which the fastening member is separated according to various embodiments;

FIG. 3B is a cross-sectional view of the strap and the fastening member taken along plane A in FIG. 2A in the state in which the fastening member is separated according to various embodiments;

FIG. 3C is a cross-sectional view of the strap and the fastening member taken along plane A in FIG. 2A in the state in which the fastening member is coupled according to various embodiments;

FIG. 4A is an exploded perspective view of the fastening member according to various embodiments;

FIG. 4B is an enlarged perspective view of a portion of the first fastening member according to various embodiments;

FIG. 4C is a perspective view illustrating the buckle and the buckle connection pin in a first state according to various embodiments;

FIG. 4D is a perspective view illustrating the buckle and the buckle connection pin in a second state according to various embodiments;

FIG. 5A is a cross-sectional view illustrating the strap, the buckle connection pin in the first state, and the fastening member in the state in which the fastening member is coupled according to various embodiments;

FIG. 5B is a cross-sectional view illustrating the strap, the buckle connection pin in the second state, and the fastening member, in the state in which the fastening member is separated according to various embodiments;

FIG. 6 is a cross-sectional view of a strap and a fastening member including a buckle connection pin in the first state, according to various embodiments;

FIG. 7A is an exploded perspective view of the strap and the fastening member according to various embodiments; and

FIG. 7B is a cross-sectional view of the strap and the fastening member according to various embodiments.

### DETAILED DESCRIPTION

The following description made with reference to the accompanying drawings may be provided to aid in understanding various implementations of the disclosure. Various example embodiments set forth in the following description include various particular details to aid in understanding. Therefore, it will be apparent to those skilled in the art that various changes and modifications may be made to various implementations described herein without departing from the scope and technical idea of the disclosure. In addition, descriptions of well-known functions and configurations may be omitted for clarity and brevity.

The terms and words used in the following description and claims are not limited to bibliographical meanings, but may be used to clearly and consistently describe the various embodiments set forth herein. Therefore, it will be apparent to those skilled in the art that the following description of various implementations of the disclosure is provided only for the purpose of explanation, rather than for the purpose of limiting the disclosure defined as the scope of protection and equivalents thereto.

It should be appreciated that a singular form such as “a,” “an,” or “the” also includes the meaning as a plural form, unless the context clearly indicates otherwise. Therefore, for example, “a component surface” may refer, for example, to one or more of component surfaces.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used herein, the term “module” may include a unit implemented in hardware, software, or firmware, or any combination thereof, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., a program) including one or more instructions that are stored in a storage medium (e.g., internal memory or external memory) that is readable by a machine (e.g., an electronic device). For example, a processor (e.g., the processor) of the machine (e.g., the electronic device) may invoke at least one of the one or more stored instructions from the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

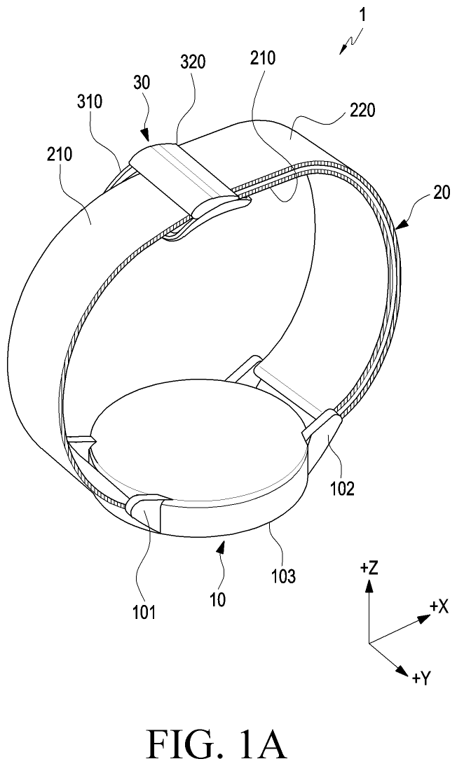

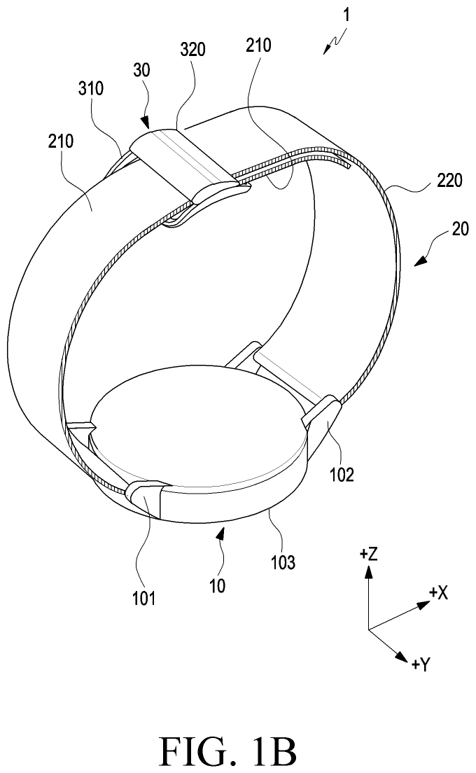

FIGS. 1A and 1B are perspective views of a wearable device according to various embodiments.

Referring to FIGS. 1A and 1B, according to various embodiments, a wearable device 1 may include a display assembly 10, a strap 20, and a fastening member 30. Hereinafter, the term, wearing member, may be used as a term encompassing the strap 20 and/or the fastening member 30.

According to various embodiments, the display assembly 10 may include a first fixing portion 101, a second fixing portion 102, and a display 103. The first fixing portion 101 and the second fixing portion 102 may be arranged to be opposite to each other. The display 103 may be disposed between the first fixing portion 101 and the second fixing portion 102. The first fixing portion 101 and the second fixing portion 102 may be connected to the strap 20. According to an embodiment, the strap 20 may be configured to be at least partially connected to or fixed to the first fixing portion 101 and the second fixing portion 102.

According to various embodiments, the strap 20 may include a first strap 210 and a second strap 220. According to an embodiment, the first strap 210 and the second strap 220 may be a single strap 20, and according to an embodiment, the first strap 210 and the second strap 220 may include two straps 20.

Referring to FIG. 1A, according to various embodiments, the first strap 210 and the second strap 220, which include a single strap 20, are illustrated. According to an embodiment, the first strap 210 may be connected to the first fixing portion 101 and may extend to the second fixing portion 102 through the fastening member 30. The second strap 220 may extend from the first strap 210 passing through the second fixing portion 102, and may be connected to the fastening member 30.

Referring to FIG. 1B, according to various embodiments, the first strap 210 and the second strap 220, which include second straps 20, are illustrated. According to an embodiment, the first strap 210 may be connected to the first fixing portion 101, and the second strap 220 may be connected to the second fixing portion 102. The first strap 210 and the second strap 220 may be connected to the fastening member 30.

According to various embodiments, the fastening member 30 may include a first fastening member (e.g., fastener) 310 and a second fastening member (e.g., fastener) 320. The fastening member 30 may be configured to be connected to the strap 20. According to an embodiment, the first fastening member 310 may be connected to the first strap 210, and the second fastening member 320 may be connected to the second strap 220. According to an embodiment, the first strap 210 may be configured to penetrate the first fastening member 310.

Hereinafter, the strap 20 and the fastening member 30 illustrated in FIGS. 1A and 1B will be described in greater detail with reference to various figures.

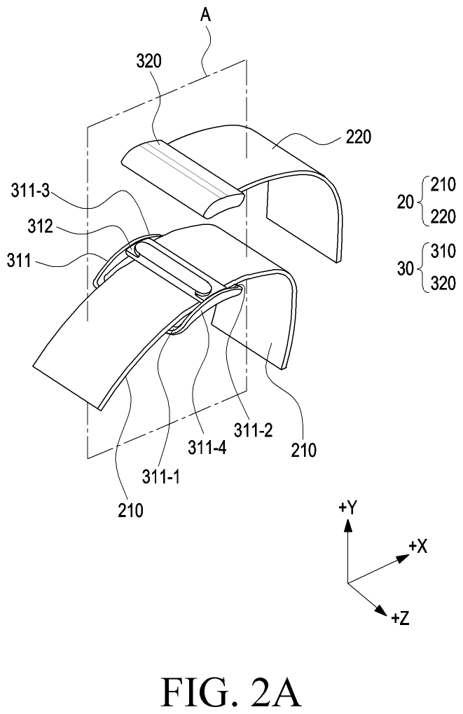

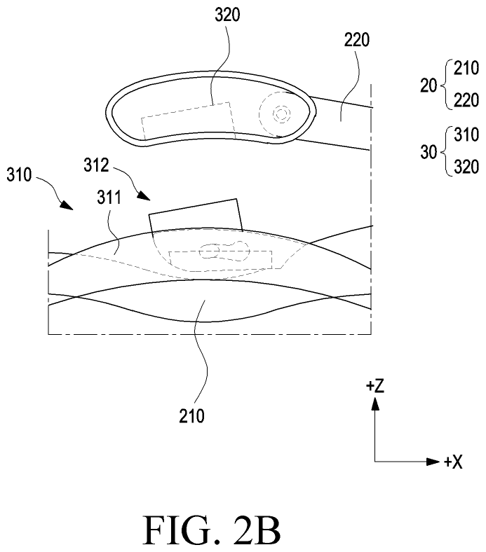

FIG. 2A is a perspective view of the strap and the fastening member in the state in which the fastening member is separated according to various embodiments, and FIG. 2B is a side view of the strap and the fastening member in the state in which the fastening member is separated according to various embodiments.

The strap 20, the first strap 210, the second strap 220, the fastening member 30, the first fastening member 310, and the second fastening member 320 illustrated in FIGS. 2A and 2B may be the same as or similar to the strap 20, the first strap 210, the second strap 220, the fastening member 30, the first fastening member 310, and the second fastening member 320 illustrated in FIGS. 1A and 1B. Therefore, descriptions of the same components may not be repeated here.

Referring to FIGS. 2A and 2B, according to various embodiments, the first fastening member 310 and the second fastening member 320 of the fastening member 30 may be configured to be separated from and coupled to each other.

According to various embodiments, the first fastening member 310 may include a buckle 311 and a buckle connection pin 312. The buckle 311 may have a ring shape when viewed from above. According to an embodiment, the buckle 311 may have a square ring shape. The buckle 311 may include a first side 311-1 and a second side 311-2 that face each other. The buckle 311 between the first side 311-1 and the second side 311-2 may have an arch shape when viewed from a side. The buckle 311 may include a third side 311-3 and a fourth side 311-4 connected to the first side 311-1 and the second side 311-2 and facing each other. The buckle connection pin 312 may be connected to the third side 311-3 and the fourth side 311-4 of the buckle 311. The strap 20 may pass through the space between the buckle connection pin 312 and the buckle 311. According to an embodiment, the first strap 210 may pass through the space between the buckle connection pin 312 and the first side 311-1, and may pass through the space between the buckle connection pin 312 and the second side 311-2. In this way, as the first strap 210 passes through the space between the buckle 311 and the buckle connection pin 312, the first fastening member 310 may be slidable in the longitudinal direction (the +X-axis direction) of the first strap 210. In addition, when a user wears the wearable device 1, at least a portion of the buckle connection pin 312 presses the strap 20 in one direction (the −Y-axis direction), so that the strap 20 can be fixed to the fastening member 30 due to the friction between the strap 20 and the fastening member 30.

According to various embodiments, the second fastening member 320 may be connected to the second strap 220. The second fastening member 320 may be configured to be connected to the first fastening member 310. According to an embodiment, the first fastening member 310 and the second fastening member 320 may be configured to be coupled to each other. A concave groove may be provided in at least a portion of the first fastening member 310, and a convex protrusion may be provided in at least a portion of the second fastening member 320. The convex protrusion of the second fastening member 320 may be fitted into the concave groove of the first fastening member 310 so that the convex protrusion and the concave groove can be coupled to each other.

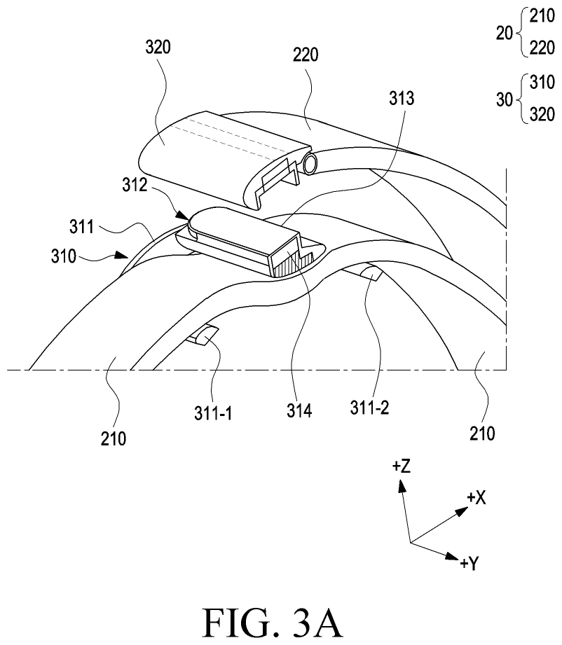

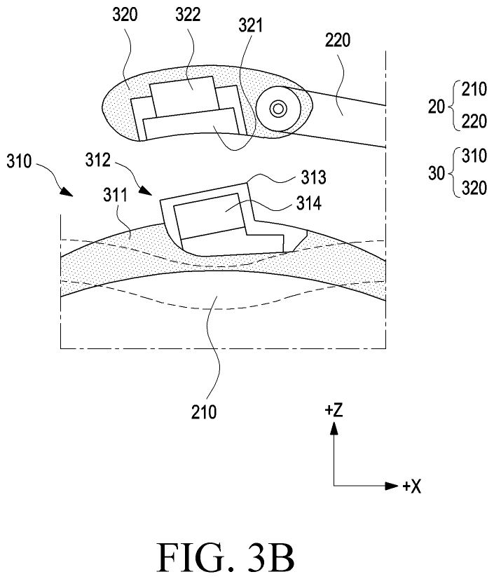

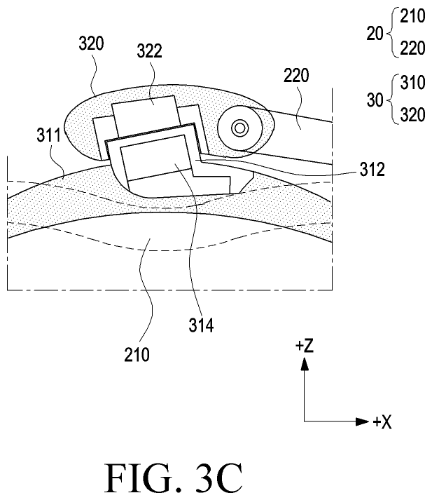

FIG. 3A is a perspective view of the strap 20 and the fastening member 30 in which a cross section cut along plane A in FIG. 2A is illustrated in the state in which the fastening member is separated according to various embodiments, FIG. 3B is a cross-sectional view of the strap 20 and the fastening member 30 taken along plane A in FIG. 2A in the state in which the fastening member is separated according to various embodiments, and FIG. 3C is a cross-sectional view of the strap 20 and the fastening member 30 taken along plane A in FIG. 2A in the state in which the fastening member is coupled according to various embodiments.

The strap 20, the first strap 210, the second strap 220, the fastening member 30, the first fastening member 310, the buckle 311, the buckle connection pin 312, and the second fastening member 320 illustrated in FIGS. 3A, 3B, and 3C may be the same as or similar to the strap 20, the first strap 210, the second strap 220, the fastening member 30, the first fastening member 310, the buckle 311, the buckle connection pin 312, and the second fastening member 320 illustrated in FIGS. 1A, 1B, 2A, and 2B. Therefore, descriptions of the same components may not be repeated here.

FIGS. 3A and 3B illustrate the fastening member 30 in the separated state, and FIG. 3C illustrates the fastening member 30 in the coupled state. Referring to FIGS. 3A, 3B, and 3C, the fastening member 30 may include a first fastening member 310 and a second fastening member 320.

According to various embodiments, the first fastening member 310 may include a buckle 311 and a buckle connection pin 312. The buckle connection pin 312 may include a buckle protrusion 313 and a first magnet 314. The buckle protrusion 313 may protrude in a direction away from the second strap 220. The first magnet 314 may be disposed inside the buckle protrusion 313.

According to various embodiments, the second fastening member 320 may include a concave groove 321 and a second magnet 322. The second magnet 322 may be disposed above the concave groove 321 (in the +Z-axis direction).

According to various embodiments, the buckle protrusion 313 and the concave groove 321 may be coupled to each other. As the buckle protrusion 313 and the concave groove 321 are coupled to each other, the distance between the first magnet 314 and the second magnet 322 may become closer. As the distance between the first magnet 314 and the second magnet 322 becomes closer, the magnitude of the magnetic force acting as attraction may increase, and the coupling force between the first fastening member 310 and the second fastening member 320 may increase.

Referring to FIGS. 3B and 3C, according to various embodiments, it can be seen that the coupling surface between the first fastening member 310 and the second fastening member 320 forms a predetermined angle with the longitudinal direction of the strap 20 (the X-axis direction) on the cross section (the X-Z plane). In this way, as the coupling surface between the first fastening member 310 and the second fastening member 320 forms a predetermined angle with the longitudinal direction of the strap 20 (the X-axis direction) on the cross section (the X-Z plane), the width magnet of the magnet (the X-axis direction) may increase. As the width of the magnets increases, the magnetic force between the magnets increases, and the coupling force between the first fastening member 310 and the second fastening member 320 may increase.

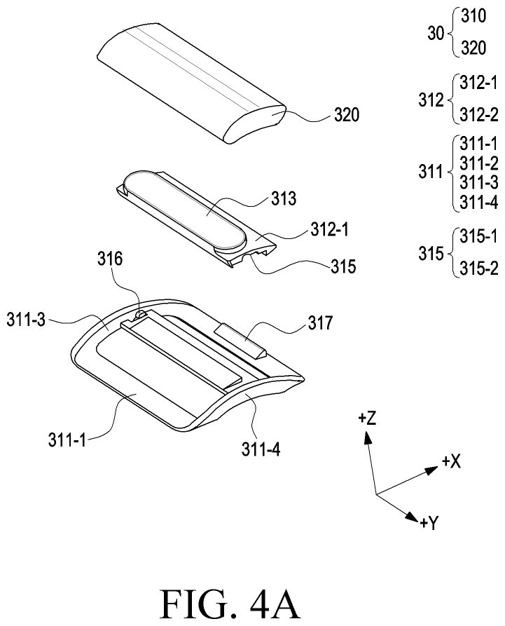

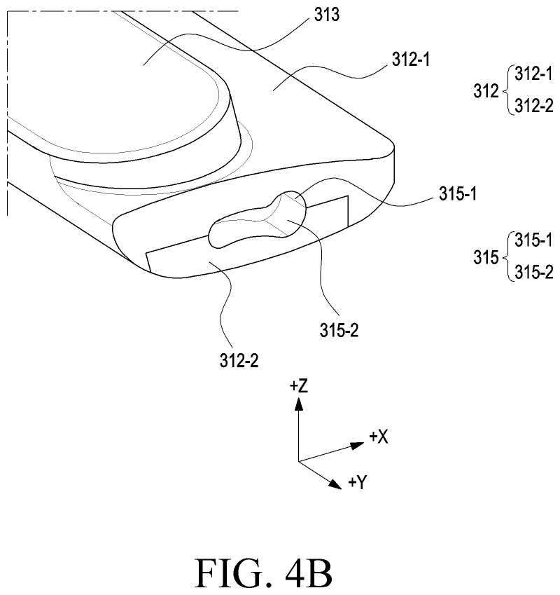

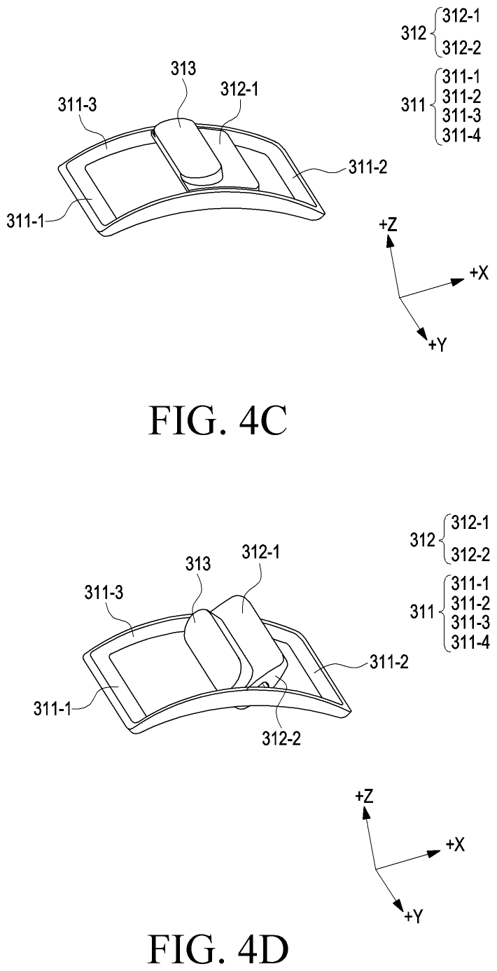

FIG. 4A is an exploded perspective view of the fastening member according to various embodiments, and FIG. 4B is an enlarged perspective view of a portion of the first fastening member according to various embodiments. FIG. 4C is a perspective view illustrating the buckle and the buckle connection pin in a first state according to various embodiments, and FIG. 4D is a perspective view illustrating the buckle and the buckle connection pin in a second state according to various embodiments.

The fastening member 30, the first fastening member 310, the buckle 311, the first side 311-1, the second side 311-2, the third side 311-3, the fourth side 311-4, the buckle connection pin 312, the buckle protrusion 313, and the second fastening member 320 illustrated in FIGS. 4A to 4D may be the same as or similar to the fastening member 30, the first fastening member 310, the buckle 311, the first side 311-1, the second side 311-2, the third side 311-3, the fourth side 311-4, the buckle connection pin 312, the buckle protrusion 313, and the second fastening member 320 illustrated in FIGS. 1A to 3C. Therefore, descriptions of the same components may not be repeated here.

According to various embodiments, the buckle connection pin 312 may include an upper buckle connection pin portion 312-1 and a lower buckle connection pin portion 312-2. The upper buckle connection pin portion 312-1 and the lower buckle connection pin portion 312-2 may be separated from or coupled to each other. A coupling groove 315 may be provided in the buckle connection pin 312. The coupling groove 315 may include an upper coupling groove 315-1 provided in the upper buckle connection pin portion 312-1 and a lower coupling groove 315-2 provided in the lower buckle connection pin portion 312-2.

According to various embodiments, coupling bumps 316 may be provided on the third side 311-3 and the fourth side 311-4 of the buckle 311. The coupling bumps 316 may be configured to be inserted into the coupling groove 315. As the coupling bumps 316 are inserted into the coupling groove 315, the buckle connection pin 312 may be configured to be coupled to the buckle 311.

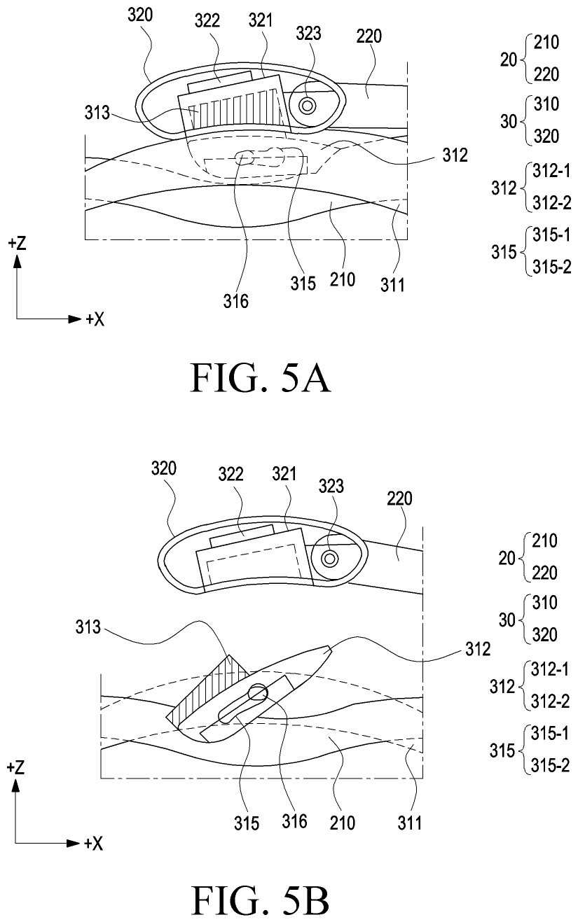

Referring to FIG. 4B, according to various embodiments, the cross section of the coupling groove 315 may have a closed curve shape that is larger than the area of the coupling bump 316. As the coupling groove 315 is formed in the closed curve shape, the coupling groove 315 may move relative to the coupling bump 316. As the coupling groove 315 moves relative to the coupling bump 316, the buckle connection pin 312 may move to be provided in the first state and the second state. The first and second states of the buckle connection pin 312 will be described later with reference to FIGS. 5A and 5B.

Referring to FIG. 4C, according to various embodiments, the buckle 311 and the buckle connection pin 312 may be arranged in parallel to each other. The state in which the buckle connection pin 312 is arranged approximately in parallel to the buckle 311 may be defined as the buckle connection pin 312 in the first state. The buckle connection pin 312 in the first state illustrated in FIG. 4C may be the same as or similar to the buckle connection pin 312 in the first state illustrated in FIG. 5A.

Referring to FIG. 4D, according to various embodiments, the buckle 311 and the buckle connecting pin 312 may be arranged to form a predetermined angle. The state in which the buckle connection pin 312 is arranged to form a predetermined angle rather than in parallel to the buckle 311 may be defined as the second state of the buckle connection pin 312. The buckle connection pin 312 in the second state illustrated in FIG. 4D may be the same as or similar to the buckle connection pin 312 in the second state illustrated in FIG. 5B.

FIG. 5A is a cross-sectional view illustrating the strap, the buckle connection pin in the first state, and the fastening member in the state in which the fastening member is coupled according to various embodiments, and FIG. 5B is a cross-sectional view illustrating the strap, the buckle connection pin in the second state, and the fastening member in the state in which the fastening member is separated according to various embodiments.

The strap 20, the first strap 210, the second strap 220, the fastening member 30, the first fastening member 310, the buckle 311, the buckle connection pin 312, the buckle protrusion 313, the coupling groove 315, the coupling bump 316, the second fastening member 320, and the concave groove 321 illustrated in FIGS. 5A and 5B are the same as or similar to the strap 20, the first strap 210, the second strap 220, the fastening member 30, the first fastening member 310, the buckle 311, the buckle connection pin 312, the buckle protrusion 313, the coupling groove 315, the coupling bump 316, the second fastening member 320, and the concave groove 321 illustrated in FIGS. 1A to 4B. Therefore, descriptions of the same components may not be repeated here.

Referring to FIG. 5A, according to various embodiments, the first fastening member 310 and the second fastening member 320 may be coupled to each other. When the first fastening member 310 and the second fastening member 320 are coupled to each other, the buckle connection pin 312 may be provided in the first state. The buckle connection pin 312 in the first state may be arranged in approximately parallel to the tangential direction of the strap 20 adjacent thereto. The coupling bump 316 may be disposed at one end of the coupling groove 315 of the buckle connection pin 312 in the first state.

As described above with reference to FIGS. 3B and 3C, the coupling surface between the first fastening member 310 and the second fastening member 320 may form a predetermined angle with the longitudinal direction of the strap 20 (the X-axis direction) on the cross section (the X-Z plane). Accordingly, the magnets are arranged diagonally, so that the lengths of the magnets (e.g., the first magnet 314 and the second magnet 322) may be formed to be long so the length of the buckle connection pin 312 (in the X-axis direction) can be minimized and/or reduced. Accordingly, the coupling force of the fastening member 30 may be increased while keeping the size of the fastening member 30 the same, or the size of the fastening member 30 may be reduced while maintaining the coupling force of the fastening member 30.

In addition, since the coupling surface between the first fastening member 310 and the second fastening member 320 forms a predetermined angle with the longitudinal direction of the strap 20 (the X-axis direction), a clockwise torque is generated in the second fastening member 320 by the tension of the second strap 220. The clockwise torque generated in the second fastening member 320 is transmitted to the first fastening member 310, the first fastening member 310 presses the first strap 210 clockwise, and the first strap 210 is supported by the user's wrist. As a result, the coupling force of the fastening member 30 can be increased.

In addition, since the coupling surface of the first fastening member 310 and the second fastening member 320 forms a predetermined angle with the longitudinal direction of the strap 20 (the X-axis direction), the first magnet 314 and the second magnet 322 are coupled in a hook-like shape, so that the coupling of the first fastening member 310 and the second fastening member 320 can be firmly maintained no matter which direction force is applied.

Referring to FIG. 5B, according to various embodiments, the first fastening member 310 and the second fastening member 320 may be separated from each other. When the first fastening member 310 and the second fastening member 320 are separated from each other, the buckle connection pin 312 may be provided in the second state. The buckle connection pin 312 in the second state may be arranged to form a predetermined angle with the tangential direction of the strap 20 adjacent thereto. The coupling bump 316 may be disposed at the other end of the coupling groove 315 of the buckle connection pin 312 in the second state. In a plane (the X-Z plane), the width direction of the buckle connection pin 312 in the second state may be arranged to face the space between the X axis and the Z axis. When the buckle connection pin 312 is in the second state, the user may easily make the strap 20 pass through the space between the buckle connection pin 312 and the buckle 311. After the user adjusts the strap 20 to an appropriate length, the user may horizontally move and rotate the buckle connection pin 312 in the second state to switch the buckle connection pin 312 into the first state.

Referring to FIGS. 5A and 5B, according to various embodiments, the buckle connection pin 312 in the first state and the buckle connection pin 312 in the second state may be placed at different positions and at different angles. The coupling groove 315 of the buckle connection pin 312 is larger than the coupling bump 316 of the buckle 311, so that the coupling groove 315 is movable with respect to the coupling bump 316. Since the coupling groove 315 moves relative to the coupling bump 316 as described above so that two states can be provided by the buckle connection pin 312, the user may conveniently wear the wearable device including the wearing member.

According to various embodiments, the second fastening member 320 may include a hinge portion 323. The hinge portion 323 may interconnect the second fastening member 320 and the second strap 220. According to an embodiment, the second fastening member 320 may rotate while moving horizontally with respect to the hinge portion 323. Accordingly, the second fastening member 320 and the second strap 220 may move and rotate relative to each other.

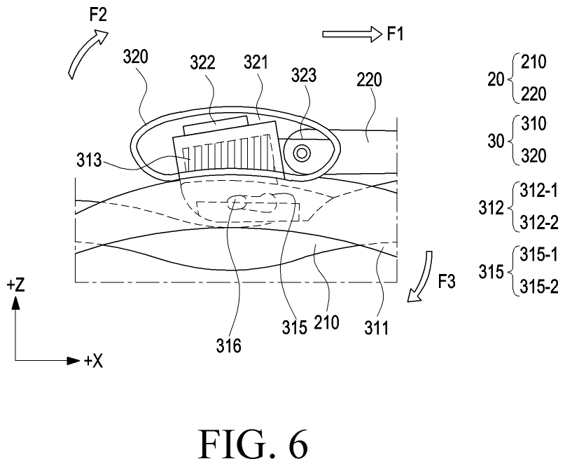

FIG. 6 is a cross-sectional view of a strap and a fastening member including a buckle connection pin in the first state, according to various embodiments.

The strap 20, the first strap 210, the second strap 220, the fastening member 30, the first fastening member 310, the buckle 311, the buckle connection pin 312, the buckle protrusion 313, the coupling groove 315, the coupling bump 316, the second fastening member 320, and the concave groove 321 illustrated in FIG. 6 are the same as or similar to the strap 20, the first strap 210, the second strap 220, the fastening member 30, the first fastening member 310, the buckle 311, the buckle connection pin 312, the buckle protrusion 313, the coupling groove 315, the coupling bump 316, the second fastening member 320, and the concave groove 321 illustrated in FIGS. 1A to 5B. Therefore, descriptions of the same components may not be repeated here.

Referring to FIG. 6, according to various embodiments, tension may be generated in the strap 20 of the wearable device 1 including the buckle connection pin 312 in the first state. According to an embodiment, a tension F1 may be generated in the second strap 220. The direction of the tension generated in the second strap 220 may be approximately in the +X-axis direction.

As described above with reference to FIGS. 3B and 3C, the coupling surface between the first fastening member 310 and the second fastening member 320 may form a predetermined angle with the longitudinal direction of the strap 20 (the X-axis direction) on the cross section (the X-Z plane). Accordingly, a first clockwise torque (torque F2) may be generated in the second fastening member 320 by the tension F1 of the second strap 220. The first clockwise torque F2 generated in the second fastening member 320 may be transmitted to the first fastening member 310 coupled to the second fastening member 320, and a second clockwise torque F3 may be generated in the first fastening member 310. The second clockwise torque F3 acts on the first strap 210, and the first strap 210 is pressed in the −Z-axis direction due to the second torque F3 so that the strap 20 can be worn more firmly on the user's body. In this way, since the coupling surface between the first fastening member 310 and the second fastening member 320 forms a predetermined angle with the longitudinal direction of the strap 20 (the X-axis direction) on the cross section (the X-Z plane), the wearable device 1 may provide a convenient feeling of use to the user.

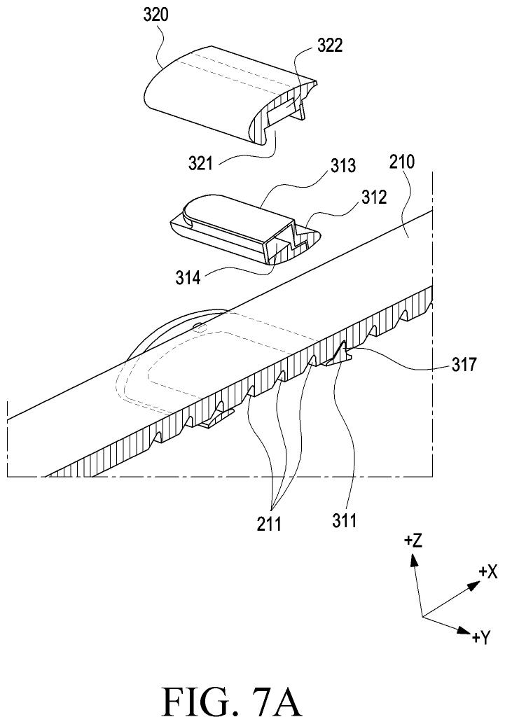

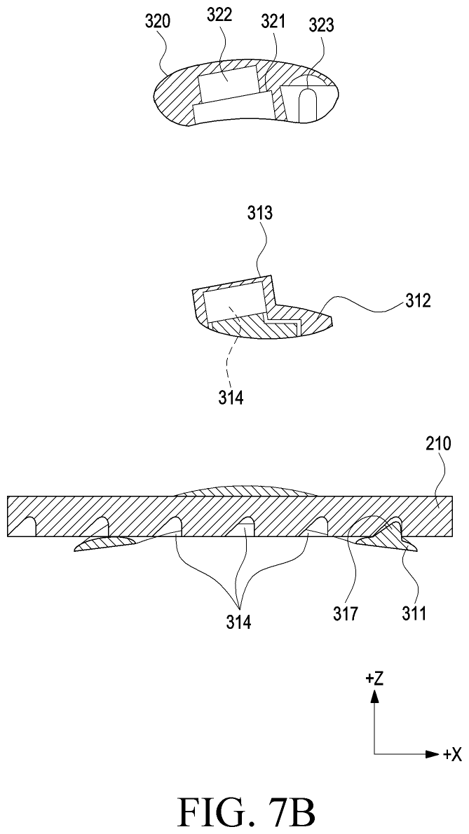

FIG. 7A is an exploded perspective view of the strap and the fastening member according to various embodiments, and FIG. 7B is a cross-sectional view of the strap and the fastening member according to various embodiments.

The strap 20, the first strap 210, the second strap 220, the fastening member 30, the first fastening member 310, the buckle 311, the buckle connection pin 312, the buckle protrusion 313, the coupling groove 315, the coupling bump 316, the second fastening member 320, and the concave groove 321 illustrated in FIGS. 7A and 7B are the same as or similar to the strap 20, the first strap 210, the second strap 220, the fastening member 30, the first fastening member 310, the buckle 311, the buckle connection pin 312, the buckle protrusion 313, the coupling groove 315, the coupling bump 316, the second fastening member 320, and the concave groove 321 illustrated in FIGS. 1A to 6. Therefore, descriptions of the same components may not be repeated here.

Referring to FIGS. 7A and 7B, according to various embodiments, locking grooves 211 may be provided on one surface of the first strap 210 at the bottom side (the −Z-axis direction). The locking grooves 211 may have triangular shapes. The locking grooves 211 may each have a shape that is further inclined in the +X-axis direction as it progresses in the +Z-axis. According to various embodiments, a locking bump 317 may be provided on at least a portion of the buckle 311. According to an embodiment, the locking bump 317 may be provided on the second side 311-2 of the buckle 311. The locking bump 317 may have a triangular shape. The locking bump 317 may have a shape that is further inclined in the +X-axis direction as it progresses in the +Z-axis.

According to various embodiments, each locking groove 211 and the locking bump 317 may be inclined at a predetermined angle in the direction in which the first strap 210 and the second strap 220 are arranged together with respect to the fastening member 30.

According to various embodiments, the locking bump 317 may be inserted into one of the locking grooves 211. As the locking bump 317 is inserted into one of the locking grooves 211, the buckle 311 can be fixed to the first strap 210. As the buckle 311 is fixed to the first strap 210, user convenience for the wearable device 1 can be improved.

Although significant progress has been made to allow wearable devices to be carried or used while being worn on users' bodies, user demands for wearable devices to be more comfortable to wear and lighter are increasing. In addition, as wearable devices are carried or used while being worn on the users' bodies, user demands are increasing not only for their functions and performance, but also for their usability as an accessory that is capable of expressing each user's personality.

Various embodiments disclosed herein are capable of providing a wearable device that can be worn appropriately on the bodies of various users while allowing the wearing member to be easily put on and taken off.

The problems addressed in the disclosure are not limited to the above-mentioned problems, and additional aspects according to various embodiments are presented through the detailed description, and may be partially clear from the description or understood through the presented embodiments.

With a wearing member and a wearable device including the wearing member according to various embodiments of the disclosure, the size of the fastening member can be reduced and the coupling force can be made stronger.

Accordingly, users can easily put on and take off the wearable device including the wearing member, and user convenience can be improved.

According to various example embodiments of the disclosure, a wearing member may include: a strap (e.g., the strap 20 in FIGS. 1A and 1B) including a first strap (e.g., the first strap 210 in FIGS. 1A and 1B) and a second strap (e.g., the second strap 220 in FIGS. 1A and 1B), and a fastening member (e.g., the fastening member 30 in FIGS. 1A and 1B) including a first fastening member comprising a fastener (e.g., the first fastening member 310 in FIGS. 1A and 1B) and a second fastening member comprising a fastener (e.g., the second fastening member 320 in FIGS. 1A and 1B). The first strap may pass through the first fastening member including a first magnet (e.g., the first magnet 314 in FIG. 3B), the second strap may be fixed to one end of the second fastening member including a second magnet (e.g., the second magnet 322 in FIG. 3B), the first fastening member and the second fastening member may be configured to be stacked and coupled to each other, and on a longitudinal cross section of the strap, a normal line with respect to a coupling surface between the first fastening member and the second fastening member may have an angle greater than 90 degrees with a tensile direction of the second strap applied to the second fastening member.

According to various example embodiments, the first fastening member may include a buckle (e.g., the buckle 311 in FIG. 3B) and a buckle connection pin (e.g., the buckle connection pin 312 in FIG. 3B), and the buckle connection pin may be configured to rotate with respect to the buckle.

According to various example embodiments, a buckle protrusion (e.g., the buckle protrusion 313 in FIG. 3B) provided on the buckle may protrude in a direction away from the second strap on a longitudinal cross section of the strap.

According to various example embodiments, a coupling bump (e.g., the coupling bump 316 in FIG. 4A) may be provided on the buckle, a coupling groove (e.g., the coupling groove 315 in FIG. 4A) may be provided on the buckle connection pin, and the coupling bump may be inserted into the coupling groove.

According to various example embodiments, the buckle connection pin may include an upper buckle connection pin portion (e.g., the upper buckle connection pin portion 312-1 in FIG. 4A) and a lower buckle connection pin portion (e.g., the lower buckle connection pin portion 312-2 in FIG. 4A), and the coupling groove may include an upper coupling groove (e.g., the upper coupling groove 315-1 in FIG. 4B) and a lower coupling groove (e.g., the lower coupling groove 315-2 in FIG. 4B).

According to various example embodiments, a first state in which the coupling bump is disposed at one end of the coupling groove, and a second state in which the coupling bump is disposed at a remaining end of the coupling groove may be provided.

According to various example embodiments, a plurality of locking grooves (e.g., the locking grooves 211 in FIG. 7B) are provided in the first strap, a locking bump (e.g., the locking bump 317 in FIG. 7B) is provided on the buckle, and the locking bump may be configured to be inserted into the at least one locking groove.

According to various example embodiments, the locking groove and the locking bump may have a triangular shape.

According to various example embodiments, the locking groove and the locking bump may be inclined at a specified angle in a direction in which the first strap and the second strap are arranged together with respect to the fastening member.

According to various example embodiments, the second strap may be coupled to a hinge portion (e.g., hinge portion 323 in FIG. 5A) provided on the second fastening member.

According to various example embodiments of the disclosure, a wearable device (e.g., the wearable 1 in FIGS. 1A and 1B) may include a display assembly comprising a display (e.g., the display assembly 10 in FIGS. 1A and 1B) including a first fixing portion (e.g., the first fixing portion 101 in FIGS. 1A and 1B) and a second fixing portion (e.g., the second fixing portion 102 in FIGS. 1A and 1B), a fastening member (e.g., the fastening member 30 in FIGS. 1A and 1B) including a first fastening member comprising a fastener (e.g., the first fastening member 310 in FIGS. 1A and 1B) and a second fastening member comprising a fastener (e.g., the second fastening member 320 in FIGS. 1A and 1B), and a strap connected to the display assembly (e.g., strap 20 in FIGS. 1A and 1B) and including a first strap (e.g., the first strap 210 in FIGS. 1A and 1B) connected to the first fixing portion, and a second strap (e.g., the second strap 220 in FIGS. 1A and 1B) connected to the second fixing portion. The first strap may be configured to pass through the first fastening member including a first magnet (e.g., the first magnet 314 in FIG. 3B), the second strap may be fixed to one end of the second fastening member including a second magnet (e.g., the second magnet 322 in FIG. 3B), the first fastening member and the second fastening member may be configured to be stacked and coupled to each other, and on a longitudinal cross section of the strap, a normal line with respect to a coupling surface between the first fastening member and the second fastening member may have an angle greater than 90 degrees with a tensile direction of the second strap applied to the second fastening member.

According to various example embodiments, the first fastening member may include a buckle (e.g., the buckle 311 in FIG. 3B) and a buckle connection pin (e.g., the buckle connection pin 312 in FIG. 3B), and the buckle connection pin may be configured to rotate with respect to the buckle.

According to various example embodiments, a buckle protrusion (e.g., the buckle protrusion 313 in FIG. 3B) provided on the buckle may protrude in a direction away from the second strap on a longitudinal cross section of the strap.

According to various example embodiments, a coupling bump (e.g., the coupling bump 316 in FIG. 4A) may be provided on the buckle, a coupling groove (e.g., the coupling groove 315 in FIG. 4A) may be provided on the buckle connection pin, and the coupling bump may be inserted into the coupling groove.

According to various example embodiments, the buckle connection pin may include an upper buckle connection pin portion (e.g., the upper buckle connection pin portion 312-1 in FIG. 4A) and a lower buckle connection pin portion (e.g., the lower buckle connection pin portion 312-2 in FIG. 4A), and the coupling groove may include an upper coupling groove (e.g., the upper coupling groove 315-1 in FIG. 4B) and a lower coupling groove (e.g., the lower coupling groove 315-2 in FIG. 4B).

According to various example embodiments, a first state in which the coupling bump is disposed at one end of the coupling groove, and a second state in which the coupling bump is disposed at a remaining end of the coupling groove may be provided.

According to various example embodiments, a plurality of locking grooves (e.g., the locking grooves 211 in FIG. 7B) are provided in the first strap, a locking bump (e.g., the locking bump 317 in FIG. 7B) is provided on the buckle, and the locking bump may be configured to be inserted into the at least one locking groove.

According to various example embodiments, the locking groove and the locking bump may have a triangular shape.

According to various example embodiments, the locking groove and the locking bump may be inclined at a specified angle in a direction in which the first strap and the second strap are arranged together with respect to the fastening member.

According to various example embodiments, the second strap may be coupled to a hinge portion (e.g., hinge portion 323 in FIG. 5A) provided on the second fastening member.

Although various example embodiments have been illustrated and described in the detailed description of the disclosure, it will be apparent to those skilled in the art that various modifications and changes may be made thereto without departing from the scope of the disclosure, including the appended claims and their equivalents. It will also be understood that any of the embodiment(s) described herein may be used in conjunction with any other embodiment(s) described herein.

What is claimed is:

1. A wearing member comprising:
a strap comprising a first strap and a second strap; and
a fastening member comprising a first fastener and a second fastener,
wherein the first strap is configured to pass through the first fastener including a first magnet,
the second strap is fixed to one end of the second fastener including a second magnet,
the first fastener and the second fastener are configured to be stacked and coupled to each other, and
on a cross section surface with respect to a longitudinal direction of the strap, a normal line with respect to a coupling surface of the first fastener and the second fastener has an angle greater than 90 degrees with a direction of tensile force of the second strap applied to the second fastener.

2. The wearing member of claim 1, wherein the first fastener comprises a buckle and a buckle connection pin, and
the buckle connection pin is configured to rotate with respect to the buckle.

3. The wearing member of claim 1, wherein a buckle protrusion formed on the buckle protrudes toward an opposite direction of the second strap on the cross section surface with respect to the longitudinal direction of the strap.

4. The wearing member of claim 1, wherein a coupling bump is formed on the buckle, a coupling groove is formed on the buckle connection pin, and the coupling bump is configured to be inserted into the coupling groove.

5. The wearing member of claim 1, wherein the buckle connection pin includes an upper buckle connection portion and a lower buckle connection pin portion, and the coupling groove includes an upper coupling groove and a lower coupling groove.

6. The wearing member of claim 1, wherein a first state includes a state in which the coupling bump is disposed at one end of the coupling groove, and a second state includes a state in which the coupling bump is disposed at another end of the coupling groove.

7. The wearing member of claim 1, wherein at least one locking groove is formed in the first strap,
a locking bump is formed on the buckle, and
the locking bump is configured to be inserted into the at least one locking groove.

8. The wearing member of claim 1, wherein the locking groove and the locking bump are formed in a triangular shape.

9. The wearing member of claim 1, wherein the locking groove and the locking bump are inclined at a specified angle in a direction in which the first strap and the second strap are arranged together with respect to the fastening member.

10. The wearing member of claim 1, wherein the second strap is coupled to a hinge portion formed on the second fastening member.

11. A wearable device comprising:
a display assembly including a display and comprising a first fixing portion and a second fixing portion;
a fastener comprising a first fastener and a second fastener; and
a strap connected to the display assembly, and comprising a first strap connected to the first fixing portion and a second strap connected to the second fixing portion,
wherein the first strap is configured to pass through the first fastener including a first magnet,
the second strap is fixed to one end of the second fastener including a second magnet,
the first fastener and the second fastener are configured to be stacked and coupled to each other, and
on a cross section surface with respect to a longitudinal direction of the strap, a normal line with respect to a coupling surface of the first fastener and the second fastener has an angle greater than 90 degrees with a direction of tensile force of the second strap applied to the second fastener.

12. The wearable device of claim 11,
wherein the first fastener comprises a buckle and a buckle connection pin, and
the buckle connection pin is configured to rotate with respect to the buckle.

13. The wearable device of claim 11, wherein a buckle protrusion formed on the buckle protrudes toward an opposite direction of the second strap on the cross section surface with respect to the longitudinal direction of the strap.

14. The wearable device of claim 11, wherein a coupling bump is formed on the buckle, a coupling groove is formed on the buckle connection pin, and the coupling bump is configured to be inserted into the coupling groove.

15. The wearable device of claim 11, wherein the buckle connection pin includes an upper buckle connection portion and a lower buckle connection pin portion, and the coupling groove includes an upper coupling groove and a lower coupling groove.

16. The wearable device of claim 11, wherein a first state includes a state in which the coupling bump is disposed at one end of the coupling groove, and a second state includes a state in which the coupling bump is disposed at another end of the coupling groove.

17. The wearable device of claim 11, wherein at least one locking groove is formed in the first strap,
a locking bump is formed on the buckle, and
the locking bump is configured to be inserted into the at least one locking groove.

18. The wearable device of claim 11, wherein the locking groove and the locking bump are formed in a triangular shape.

19. The wearable device of claim 11, wherein the locking groove and the locking bump are inclined at a specified angle in a direction in which the first strap and the second strap are arranged together with respect to the fastening member.

20. The wearable device of claim 11, wherein the second strap is coupled to a hinge portion formed on the second fastening member.
